(19) United States
(12) Patent Application Publication
(10) Pub. No.: US 2015/0105923 A1
(43) Pub. Date: Apr. 16, 2015

(54) METHOD FOR OPERATING A COMBINED CYCLE POWER PLANT, AND COMBINED CYCLE POWER PLANT

(71) Applicant: Wobben Properties GmbH, Aurich (DE)

(72) Inventor: Alfred Beekmann, Wiesmoor (DE)

(73) Assignee: Wobben Properties GmbH, Aurich (DE)

(21) Appl. No.: 14/381,475

(22) PCT Filed: Mar. 1, 2013
(86) PCT No.: PCT/EP2013/054219

§ 371 Date: Aug. 27, 2014

(30) Foreign Application Priority Data
Mar. 2, 2012 (DE) 10 2012 203 334.3

(51) Int. Cl. G05F 1/66; F03D 9/00

(52) U.S. Cl. CPC G05F 1/66; F03D 9/005
USPC 700/287; 290/44; 700/295

(57) ABSTRACT

The invention relates to a method for operating a power-to-gas arrangement that is to say an arrangement which generates a gas, for example hydrogen and/or methane and/or the like, from electrical energy, wherein the power-to-gas unit for generating the gas draws electrical energy from an electrical grid, to which the power-to-gas unit is connected, wherein the grid has a predetermined setpoint frequency or a setpoint frequency range, wherein the power-to-gas unit reduces the consumption of electrical power by a predetermined value or consumes no electrical power when the grid frequency of the electrical grid is below the desired setpoint frequency of the grid by a predetermined frequency value and/or when the grid frequency drops with a frequency gradient, specifically with a change over time (Δf/Δt), of which the magnitude exceeds a predetermined magnitude of change.

### BACKGROUND

### Description of the Related Art

Wind turbines have long been known and used in a variety of ways.

Wind turbines are present as standalone systems or as wind farms, comprising a plurality of individual wind turbines. It is increasingly required of such power generation facilities, such as wind turbines, but also solar plants and the like, that when the frequency of the electrical grid into which the wind turbine, the wind farm or the solar plant feeds its electrical power falls below a specific grid frequency value, which is below the setpoint value, to feed an increased power contribution into the grid in order to support the grid in this way.

As is known, the setpoint frequency of an electrical grid in the German or European interconnected grid is 50 Hz, and in the USA is 60 Hz. Other countries have adopted corresponding regulations.

This setpoint frequency can be achieved relatively well when the power drawn by the consumers connected to the grid is approximately of the same magnitude as the electrical power generated by generation units and fed into the electrical grid.

Consequently, the value of the grid frequency is also a measure for the balancing of the electrical generation on the one hand and the electrical consumption on the other hand.

If, however, the consumption exceeds the generation, that is to say if more electrical power is drawn from the grid than is fed into the electrical grid, the grid frequency thus decreases.

For this purpose, the control system and the grid management of the electrical grid provide a wide range of measures in order to support the grid, in particular in order to counteract the lowering of the grid frequency, such that the value of the frequency again comes into the range of the setpoint value.

If, however, the grid frequency falls below a predetermined first grid frequency value, for example 49 Hz or 48 Hz (this first predetermined grid frequency value may assume a completely different specific value, which is dependent on the specific topology of the grid), certain measures are taken by the grid management, for example the power consumption even of controllable bulk consumers is reduced or these consumers are even completely separated from the grid and/or certain reserve power plants are put into service and the power thereof is raised.

Wind turbines or also solar facilities, which generate electrical power, are indeed able to operate in a grid-supporting manner in a particular way in the event of underfrequency, however this is often insufficient.

It has already been proposed to operate wind turbines below their optimum, that is to say below their power curve, such that, in the case of an underfrequency, a power reserve can be connected, however such a solution is not very effective because it also means that, for the period of time in which the first predetermined grid frequency is not undershot, the energy or power yield of the wind turbine is only suboptimal and therefore a large amount of electrical power that could be supplied by wind energy is not even generated, which considerably reduces the efficiency of the wind turbine on the whole.

In the case of a certain underfrequency it has also already been proposed, temporarily for a certain period of time, for example a few hundred milliseconds or a few seconds, to draw more electrical power from the generator of a wind turbine than the wind turbine is able to generate by means of the wind. This is by all means possible due to the inertia of the generator, but also means that the generator, following the increased power output (inertia operation), delivers much less electrical power.

A disclosed solution similar to that in the aforementioned source can also be inferred from WO 2010/108910 or WO 01/86143.

Reference is also made to documents DE 10 2009 018126 A1, WO 2010/048706A1, CA 2,511,632 A1 and WO 2011/060953.

Consequently, the prior approach, ultimately using the momentary reserve from the rotating centrifugal mass of rotor and generator of the wind turbine, can at best cause an increased power to be fed into the grid for a range from 10 to 20 seconds.

Here, it is also problematic that it takes a few hundred milliseconds, if not even seconds, until the increased power consumption can be provided following triggering of the switching event for example undershooting of the first predetermined grid frequency value, for example 49.7 Hz and/or exceeding a predetermined frequency gradient (ΔF/Δt).

### BRIEF SUMMARY

One or more embodiments of the present invention are to improve the previous support of the grid in the form of an inertia emulation, in particular to reduce the reaction time when a predetermined grid frequency value is undershot and/or when a determined frequency drop gradient is exceeded, and in particular in such a case also to provide the electrical power increase for a longer period of time than previously in order to thus support the grid better than previously for the case of an underfrequency or a certain frequency drop (frequency gradient), and in particular to provide a contribution to the frequency stability.

With the known inertia emulation by means of a wind turbine, the reaction time, that is to say the time between the triggering event, for example undershooting of a predetermined grid frequency value or overshooting of a predetermined grid frequency drop (frequency gradient), is approximately 200 to 500 or even 600 milliseconds.

With one or more embodiments of the invention, this reaction time can be drastically reduced, for example to values in the region of a few milliseconds, for examples 5 to 10 milliseconds, less than 20 or less than 100 ms.

Additional power in the case of underfrequency and/or in the case of a predetermined grid frequency drop (frequency gradient) is thus provided much more quickly than before.

The reason for the much quicker reaction time lies in the fact that previously the grid frequency, but also the grid frequency gradient, are measured continuously, for example the grid frequency can be measured every 200 microseconds (μs), and the frequency drop, that is to say the frequency gradient, can also be measured quickly, possibly at slightly longer intervals.

When these switching or trigger criteria, that is to say the undershooting of a predetermined grid frequency, for example 49.8 Hz, and/or the overshooting of a predetermined grid frequency drop (frequency gradient), for example 20-30 mHz/s, are determined, a control signal is generated in a control and data processing arrangement, which measures and determines the aforementioned values, and this control signal is used in order to be forwarded instantaneously to the control arrangement of a power-to-gas unit, where the power consumption from the grid of the power-to-gas unit can be stopped by blocking and/or opening switches, for example IGBTs (insulated gate bipolar transistors), of a rectifier of the consumption of electrical energy from the grid, wherein there is no need for this purpose for any galvanic isolation of the power-to-gas unit from the grid. For the electrolysis, the power-to-gas unit requires a direct current, which can be provided by a rectifier upon connection to the grid. This rectifier comprises the aforementioned switches, for example of the IGBT type, and, when the switches are opened or disconnected, the flow of electrical power from the grid is immediately stopped and therefore the previously consumed electrical power of the power-to-gas unit is accordingly also quickly additionally available to the grid.

Consequently, embodiments of the invention enable a reaction to an underfrequency situation or to a predetermined grid frequency drop (frequency gradient), wherein the reaction time is quicker than before (200-600 ms) by more than one power of ten, and, in particular in the case of a sharp frequency drop, for example due to the failure of a large-scale power plant of 1,000 MW, this can thus be counteracted immediately in order to prevent specific underfrequency values from being reached. If, specifically, certain underfrequency values are reached, for example a frequency value of 49 Hz, certain loads are automatically abandoned by the grid control system and a further instability of the entire electrical grid is thus created on the whole, such that further measures have to be taken in order to stabilize the entire grid.

The specific value that is set for the underfrequency so that, as proposed, the consumption of electrical power by the power-to-gas unit is stopped, is to be determined individually in each project. In an interconnected grid, a preferred underfrequency value should lie at approximately 49.8 Hz, for example.

By contrast, in an isolated grid, this underfrequency value should be lower, for example at 49 or even 48 Hz.

The value for the frequency drop, that is to say for the negative frequency gradient, can also be set individually. Here, it is desirable for this frequency drop or negative frequency gradient to lie in the range from 20 to 50 mHz per second or up to 1 to 2 Hz/sec. Values for higher frequency gradient values are indeed possible, but mean that this trigger/switching event often is not reached.

Since, as described, the power-to-gas unit is controlled depending on the presence of a predetermined frequency event in the electrical grid, it can contribute significantly to the grid support.

Here, it is particularly advantageous to operate the power-to-gas unit as part of a combined cycle power plant, wherein, within the combined cycle power plant, the electrical power is generated that is also consumed by the power-to-gas unit, and wherein the power generated within the combined cycle power plant but not consumed by the power-to-gas unit is fed into a connected electrical grid, for example also as steady power.

Here, it is preferable for the consumption of the power-to-gas unit in the normal operating situation to be approximately 2 to 10%, preferably approximately 5%, of the plant power of the electronic generator of the combined cycle power plant.

If, by way of example, the combined cycle power plant comprises a wind turbine with a nominal power of 5 MW, the nominal consumption of the power-to-gas unit should thus lie in the range from approximately 300 to 500 kW.

The power-to-gas unit can be connected in various ways to the electrical generator of the combined cycle power plant. By way of example, it is possible to lay the electrical connection of the power-to-gas unit to the output terminal of the wind turbine, of the wind farm or of the solar arrangement (photovoltaics). However, it is also possible that, when the wind turbine or the wind farm has a DC link, to then lay the electrical connection of the power-to-gas unit in this link, which would have the advantage that there is no longer any need for AC conversion. However, it is also possible for the power-to-gas unit to be connected to the electrical grid and to draw the electrical power from there, and, since the electrical generation unit of the combined cycle power plant feeds its electrical power into this grid, a certain spatial distance between the generation unit of the combined cycle power plant, that is to say a wind turbine, a wind farm or a solar arrangement, and the power-to-gas unit can thus also by all means be provided when the generation unit as well as the power-to-gas unit are connected to the grid and additionally the generation unit and the power-to-gas unit are interconnected via corresponding control, data or communication lines, whether in a wired manner (optical waveguides) or wirelessly, in order to increase the power available to the grid in the case of the undershooting of a predetermined underfrequency or in the case of the overshooting of a predetermined grid frequency drop.

Provided there is no frequency drop or also no predetermined grid frequency drop (frequency gradient), the power-to-gas unit draws electrical power in a controlled manner and generates herefrom a gas, whether hydrogen or methane or the like. Such a power-to-gas unit, with which gas is generated from electrical energy, is known for example from the company SolarFuel.

Here, the energy consumption of the power-to-gas unit, that is to say the consumption of electrical energy by this power-to-gas unit, can also be set and controlled such that the proportion in a wind turbine fluctuating over a predetermined period of time (prognosis period) and produced from the constant fluctuation of the wind is consumed in the power-to-gas unit in order to thus generate gas.

Here, the power-to-gas unit can be controlled in different ways.

For example, it is possible for the power-to-gas unit to always and constantly draw a quite specific electrical power, for example its nominal power, for example in the case of a power-to-gas unit of 1 MW nominal power an electrical power of 1 MW is then always drawn and a corresponding quantity of gas is constantly generated from this electrical power.

It is also possible, however, to control the consumption of the power such that it is dependent on the electrical power generated by the generation unit in the combined cycle power plant.

The generation can thus also be set such that the power-to-gas unit, with a corresponding design of the generation unit relative to the power-to-gas unit, always draws a specific percentage of the generated power of the generation unit, for example 10% or 20% or even more of the generated power.

Consequently, it is then possible in the underfrequency situation or in the case of the overshooting of a predetermined frequency gradient, to provide a greater electrical power, specifically 10 or 20 or more percent of the generated power of the generation unit, by stopping the electrolysis or methanation of the electrical grid almost instantaneously, and in any case within a few milliseconds.

It is also possible for the power-to-gas unit to draw so much electrical energy from the generation unit that it constantly provides the consumers in the electrical grid with a predetermined quantity of electrical power for a predetermined time (prognosis time), whereas, by contrast, the electrical power not provided by the generation unit to the consumers in the electrical grid is consumed in the power-to-gas unit.

Consequently not only can the network be supported in the case of an underfrequency, but, for the normal operation of the grid in the region of the setpoint frequency, a constant electrical base load can also be fed into the grid and therefore an electrical fluctuating load, which for example is set on the basis of the constant fluctuations of the wind or, in the case of a photovoltaic plant, on the basis of the fluctuating brightness, is never provided to the consumers in the network and therefore in particular a fluctuating proportion of the electrical power of the generation unit is not made available in the network or to the consumers thereof. The combined cycle power plant is therefore able to provide base load power, even during the described grid-stabilizing underfrequency situation and in the event that a predetermined grid gradient is overshot, and the grid feed performance of said power plant is thus increased.

One embodiment of the invention proposes operating a power-to-gas unit such that, when a first grid frequency value is undershot, for example a value of 49 Hz, the power-to-gas unit then reduces the power consumption from the grid or adjusts the power consumption by separating the power-to-gas unit from the grid. The grid is thus further provided over a few milliseconds and in the long term with a much higher electrical power contribution, which previously was still drawn from the grid by the power-to-gas unit.

As mentioned, it is also possible for the wind turbine or the wind farm or the photovoltaic plant to thus be operated such that it always feeds electrical energy into the network at a specific constant power for a specific provided duration, for example from 10 to 30 minutes, and the electrical energy that is generated via the constant amount by the wind turbine or the wind farm or the photovoltaic plant is then removed from the power-to-gas unit, such that, from a grid perspective, the combined cycle power plant generates a constant electrical power, in any case for a predetermined period of time, wherein this period of time can be set by the grid operator via a corresponding data line or by the operator of the wind turbine or the wind farm or the photovoltaic plant via a corresponding data line, and, in the event that the first grid frequency value is undershot or reached and/or in the event that a frequency drop is exceeded, the consumption of electrical power by the power-to-gas unit is then reduced or completely adjusted, as already described, such that the electrical power previously removed by the power-to-gas unit is available as a power contribution.

The advantage of the aforementioned solution lies not only in the fact that a “quasi inertia contribution” can thus always be called up from the combined cycle power plant, but also that a steadiness of the fed electrical power is also possible simultaneously and the combined cycle power plant can thus even deliver base load to the grid within certain limits.

To determine the duration of the power to be fed constantly, meteorological data are also used.

An example may clarify this:

When, for example, the current wind speed is 7 m/sec. and a meteorological prognosis is available to the extent that the wind speed will not fall below 5 m/sec. within the next 30 minutes, the value of 5 min/sec, possibly with a safety margin, for example 4.5 m/sec, is input as a measure for the constant electrical power to be output. The electrical power, which is thus drawn from the first 4.5 m/sec. wind speed is always fed into the electrical grid constantly for 30 minutes, for example.

Whenever the wind blows with a strength of more than 4.5 m/sec. within the prognosis period of 30 minutes, that is to say within the next 30 minutes, the accompanying increased wind power is also “harvested” by a wind turbine, as is usual, however the energy going beyond the 4.5 m/sec. forming part of the electrical power is made available directly or indirectly to the power-to-gas unit.

When, by reducing the power consumption of the power-to-gas unit and therefore as a result of the accompanying increased feed of electrical power into the grid (power not drawn equals the increased feed power), the grid frequency thus recovers more quickly than before, the power-to-gas unit is then not switched on again immediately or the energy consumption is not started again immediately when the first grid frequency value is exceeded, but a period of time is thus allowed to pass until the grid frequency value again assumes a value that corresponds to the setpoint value or corresponds close to the setpoint value or is even above the setpoint value, that is to say has a value of more than 50 Hz.

The power consumption of the power-to-gas unit is thus only started up again when the grid frequency has recovered and therefore a relatively high grid stability is again provided.

It is also known that, when the grid frequency exceeds a specific value, for example is 5% above its setpoint value, that is to say is at approximately 50.25 Hz, a reduction of the electrical feed of the wind turbine is then implemented and the fed power of the wind turbine is further reduced with further rising grid frequency.

This always occurs in the prior art by pitching the blades or in that electrical power provided by the generator is consumed in a chopper, that is to say a resistor, such that a reduced electrical power is ultimately fed into the grid.

By means of the combined cycle power plant, it is now also possible to copy the power reduction of the wind turbine by ultimately increased power consumption of the power-to-gas unit.

Consequently, in the event that an overfrequency is exceeded, the wind turbine thus does not reduce the output of the electrical power, but instead the power-to-gas unit takes on a higher power consumption, such that, from a grid perspective, the combined cycle power plant feeds a lower power into the grid. Here, the power reduction of the combined cycle power plant can be set by the control system of the consumption power of the power-to-gas unit. Due to the then implemented pitching of the rotor blades of the wind turbine or due to shadowing of a photovoltaic plant, the reduction of the power can also be significantly increased so as to thus make an adequate contribution to the frequency stability and therefore to the grid stability, even in the case of overfrequency.

As described, a power-to-gas unit is able to generate gas, for example hydrogen or methane or the like, from electric current, that is to say a gas that is suitable for combustion, but especially also as fuel for a motor. With the installation of large wind farms, large assemblies are necessary anyway, which were previously operated always with diesel, petrol or the like. If such assemblies are now switched to the combustion of gas, for example CH₄ (methane), the gas generated with the power-to-gas unit can also be used to drive the electric assemblies by means of which a wind farm is constructed.

When, for example, a wind turbine is constructed in a remote area, the electrical energy generated by this first wind turbine can be used in a power-to-gas unit to generate gas, such that the further wind turbines of the wind farm are constructed with the gas by providing the gas to the drive assemblies, that is to say cranes, trucks, vehicles, etc., necessary for constructing the wind turbines of a wind farm. Consequently, the wind farm would, to a high degree, require no fossil fuels for the construction, but could be constructed using “green gas”, that is to say for example wind gas in the described manner, which improves the ecological balance of the wind farm on the whole. Specifically in remote areas, the consumption of fuels is often also awkward anyway, often difficult at any rate, and therefore the fuels themselves are also very costly and, due to the generation of fuel on site, the fuel consumption costs required for the assemblies for constructing a wind farm can also be reduced in this respect. When the power-to-gas unit is then housed in a container or the like, the container with the power-to-gas unit can then be transported, following construction of the wind farm, to the next construction site.

### BRIEF DESCRIPTION OF THE SEVERAL VIEWS OF THE DRAWINGS

The invention will be explained in greater detail hereinafter on the basis of an exemplary embodiment in drawings.

FIG. 1a shows the view of a wind turbine,

FIG. 1b shows the typical structure and connection of a wind turbine,

FIG. 2 shows the view of a combined cycle power plant, comprising a wind turbine and a power-to-gas unit,

FIG. 3 shows the typical structure of a power-to-gas unit in the energy system (prior art; SolarFuel),

FIG. 4 shows an example for the power distribution before and after undershooting of a predetermined underfrequency value,

FIG. 5 shows the distribution of the powers of the combined cycle power plant before and after overshooting of a predetermined frequency drop,

FIG. 6 shows a variant according to another embodiment of the invention.

### DETAILED DESCRIPTION

Like reference signs may denote like or also similar, non-identical elements hereinafter. Hereinafter, for the sake of completeness, a wind turbine with a synchronous generator and gearless concept with a full power convertor will be explained.

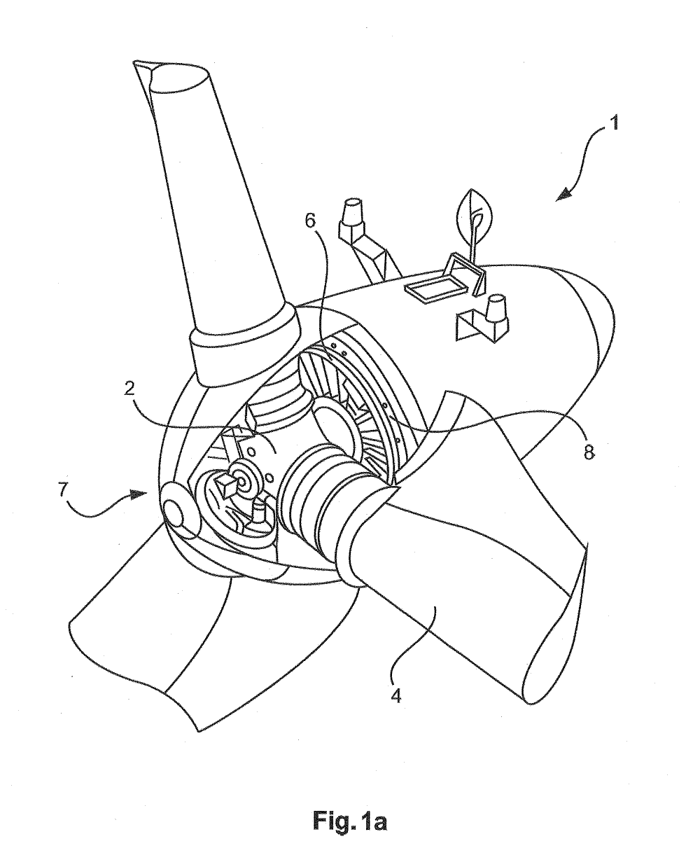

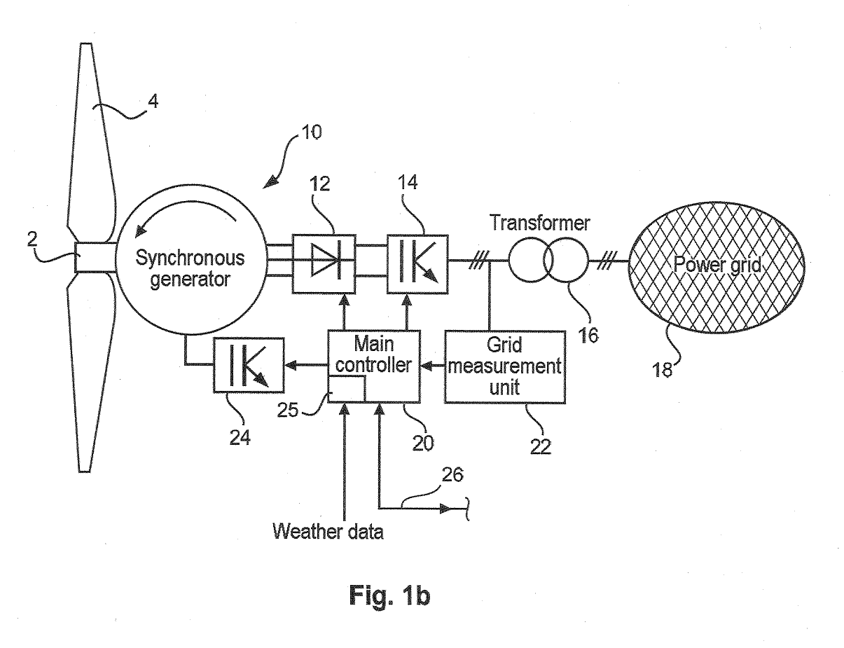

FIG. 1a schematically shows a nacelle 1 of a gearless wind turbine. The hub 2 can be seen due to the fact that the casing (spinner) is illustrated in a partly open manner. Three rotor blades 4 are fastened to the hub, wherein the rotor blades 4 are illustrated only in their region close to the hub. The hub 2 with the rotor blades 4 forms an aerodynamic rotor 7. The hub 2 is mechanically fixedly connected to the rotor 6 of the generator, which can also be referred to as an armature 6 and will be referred to hereinafter as the armature 6. The armature 6 is mounted rotatably with respect to the stator 8.

The armature 6 is energized during its rotation relative to the stator 8, usually with a direct current, in order to thus generate a magnetic field and to establish a generator torque or generator counter torque, which can also be adjusted and changed accordingly by this exciting current. If the armature 6 is thus electrically excited, its rotation with respect to the stator 8 generates an electric field in the stator 8 and therefore an electric alternating current.

The alternating current generated in the generator 10, which is formed substantially from the armature 6 and stator 8, is rectified in accordance with the structure shown in FIG. 1b via a rectifier 12. The rectified current or the rectified voltage is then converted with the aid of an inverter 14 into a 3-phase system with desired frequency. The three-phase current/voltage system thus produced is in particular subject to upward transformation in terms of the voltage by means of a transformer 16 so as to be fed into a connected power grid 18. Theoretically, the transformer could be spared or could be replaced by a choke. The voltage demands in the power grid 18, however, are usually such that an upward transformation by means of a transformer is necessary.

For control purposes, a main controller 20 is used, which can also be referred to as a main control unit and forms the uppermost regulation and control unit of the wind turbine. The main controller 20 obtains its information inter alia concerning the grid frequency from the subordinate grid measurement unit 22. The main controller controls the inverter 14 and the rectifier 12. In principle, an uncontrolled rectifier could of course also be used. In addition the main controller 20 controls a DC chopper 24 for feeding the exciting current into the armature 6, which is part of the generator 10. The main controller 20 modifies the feed or the operating point of the generator, inter alia in the event that a predefined grid frequency limit value is undershot. Since the generator is operated with variable rotational speed, the feed into the network is implemented as described with a full power convertor, which is formed substantially by the rectifier 12 and the inverter 14.

During operation, the grid voltage and grid frequency are measured permanently in a three-phase manner by the grid measurement unit 22. Every 3.3 ms, the measurement provides, at any rate in the case of a grid frequency of 50 Hz, a new value for one of the 3 phase voltages. The grid frequency is thus detected every voltage half-wave, filtered and compared with the preset limit values. For a 60 Hz system, a value for one of the 3 phase voltages would be available approximately every 2.7 ms, specifically approximately at each zero crossing.

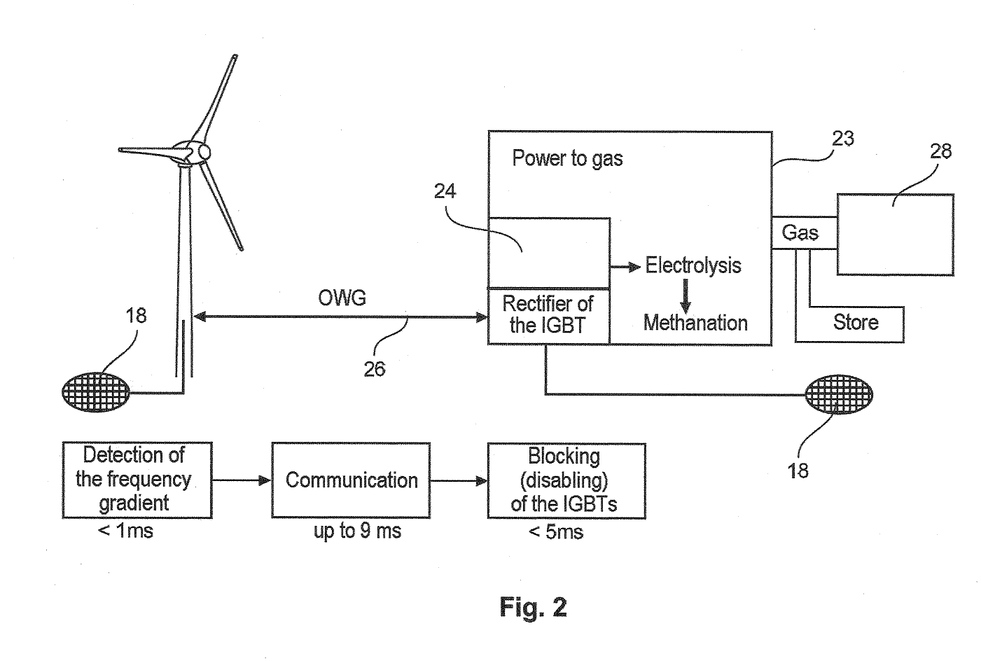

It is also illustrated in FIG. 2 that the wind turbine is electrically connected to a power-to-gas unit 23.

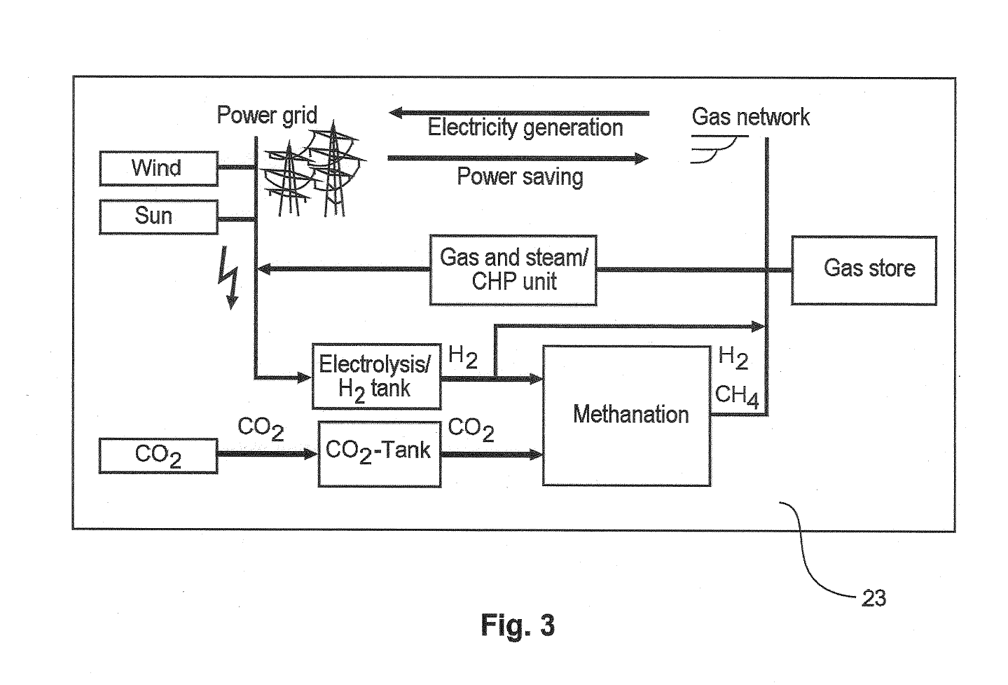

Such a power-to-gas unit 23 as such is already known in various forms, for example also from WO 2009/065577. Such a power-to-gas unit is also known from the company SolarFuel (www.SolarFuel.de) and is also illustrated schematically in FIG. 3. At such a power-to-gas unit, hydrogen is initially generated by means of an electrolysis, for which purpose electrical power is drawn from a wind turbine, a solar source or a biomass source (with electrical generation), and this power-to-gas unit 23 preferably also has a methanation unit, which uses the generated hydrogen with use of a further CO₂ source to produce methane gas (CH₄). The generated gas, whether hydrogen or methane, can be conveyed into a gas store or fed into a gas line network, for example a natural gas network.

Lastly, the power-to-gas unit 23 also has a controller 24, which is connected via a communication line, whether in a wired manner (for example optical waveguides) or wirelessly, to the main controller 20 of the wind turbine.

The power-to-gas unit is a unit in which electrical energy is consumed in order to ultimately produce a fuel gas.

For the generation of hydrogen, electrolysis is usually required by way of example, such that the power-to-gas unit has an electrolyzer for this purpose, which consumes electrical energy and thus produces hydrogen.

Methane can also be produced in the power-to-gas unit by using the hydrogen and a carbon dioxide, which for example is obtained from the air or is provided from a CO₂ tank or is provided from a connected biogas facility, to produce methane gas (CH₄) in a methanation unit.

This methane gas can be provided to a connected gas store or also fed into a gas network.

In the example illustrated in FIG. 3, a gas and steam plant or a small-scale combined heat and power (CHP) unit is also formed, in which the combustion gas is burned in an internal combustion engine, such that electrical power can in turn be generated at the electrical generator connected to the internal combustion engine and can then be provided in turn to the electrical grid.

The wind turbine may be a standalone system, however it may also be representative for a wind farm, which includes a plurality of wind turbines.

The wind turbine comprises the main controller 20 with a data processing and control device. This data processing device comprises inter alia a data input 25, via which wind prognosis data are provided to the data processing device. The data processing device 20 creates a wind prognosis on the basis of this wind prognosis data for a predetermined prognosis period, for example 20, 30, 40, 50 or 60 minutes or longer, and, on the basis of the created wind prognosis by processing the power curve of the wind turbine or of the wind farm, can also very reliably determine a prognosis power, that is to say an electrical minimum power, which can ultimately be provided reliably and constantly to the grid.

At the same time, the wind turbine or the wind farm currently always re-determines the current electrical power of the wind turbine, which is dependent on the current wind, for example at intervals from 5 to 10 seconds.

The current power of the wind energy, which, here, is above the prognosis power (minimum power), is fed as information, item of data, signal, etc., to the control and data processing device 24 of the power-to-gas unit 23, such that the electrical consumption is predefined for the power-to-gas unit 23.

If, for example in the wind turbine or in the wind farm, a prognosis power of 1 megawatt (MW) has thus been determined, but the wind turbine or the wind farm currently generates a power of 1.3 MW, the difference, that is to say 300 kW, is thus determined as a value and the control and data processing device 24 of the power-to-gas unit 23 obtains this value as a control value, such that the power-to-gas unit 23 is then operated accordingly with a consumption of 300 kW.

If the wind decreases slightly and a current power of just 1.2 MW is still then provided, the electrical consumption of the power-to-gas unit also decreases accordingly to 200 kW, and if the wind increases, such that the wind turbine or the wind farm generates 1.4 MW, the consumption of the power-to-gas unit thus rises accordingly to 400 kW, etc.

Once the prognosis period has elapsed, a new prognosis is established and a new constant power (new prognosis power) is in turn determined for this new prognosis.

Current wind data or the data concerning the consumption power of the power-to-gas unit can also be exchanged by the common data line 26 between the control and data processing device of the wind turbine or of the wind farm on the one hand and the control and data processing device of the power-to-gas unit on the other hand in order to thus ensure the constant provision of the constant minimum power fed into the power grid.

The control and data processing device 20 is additionally also connected to a controller 27 or a control center for controlling the electrical grid of the power grid, such that the value of the constant electrical feed into the electrical grid can always be called up or is present there.

If the current wind speed and therefore the current generated electrical power of the wind turbine or of the wind farm falls below the prognosis power, the electrical consumption of the power-to-gas unit is reduced to “zero” (or to a lowest possible value) and at the same time a steam-fired power plant and gas- and steam-fired power plant or small-scale CHP unit 28 can possibly be started up in order to provide additional electrical power, which cannot be provided by the wind turbine or the wind farm, such that, as a result, the electrical prognosis power can still be provided reliably to the power grid, and as necessary even more power, by accordingly operating the gas- and steam-fired power plant/small-scale CHP unit with a higher power than is necessary.

As illustrated in FIG. 1b, a communication and/or data line is provided between the generation unit of the combined cycle power plant, that is to say for example the wind farm on the one hand and the power-to-gas unit on the other hand. Subsequent data can be exchanged between the units of the combined cycle power plant via this communication and data line in order to thus control the wind farm on the one hand and/or the power-to-gas unit on the other hand

When, for example, the wind turbine or the wind farm constantly detects and measures the frequency of the electrical grid anyway and in so doing also constantly detects the frequency drop, that is to say the negative frequency gradient (drain of the frequency over time; df/dt), the corresponding values for the grid frequency (absolute value) and for the grid drop (frequency gradient) of the control device are thus transmitted to the power-to-gas unit. It is also possible, however, to generate a corresponding switching command to stop the power-to-gas unit already in the wind farm on the basis of the presence of certain predetermined frequency values or frequency gradient values and to then transmit this switching command to the power-to-gas unit. It is also possible for the generation unit, that is to say the wind farm, to transmit the current value for the currently generated electrical power to the power-to-gas unit, such that this is always operated such that no more electrical power is consumed than is generated by the generation unit.

It is also advantageous if the power-to-gas unit for its part always transmits the value of the current electrical consumption power of the overall power-to-gas unit to the generation unit so that this can be controlled accordingly.

It is also advantageous when the wind farm and/or the power-to-gas unit has a data input, such that, by means of a controller or the control center for controlling a grid, it is possible to always specify what power the power-to-gas unit is to draw, such that this power is reliably available as power for grid support if a predetermined grid frequency value is undershot and/or a predetermined grid frequency drop, that is to say a predetermined frequency gradient, is present.

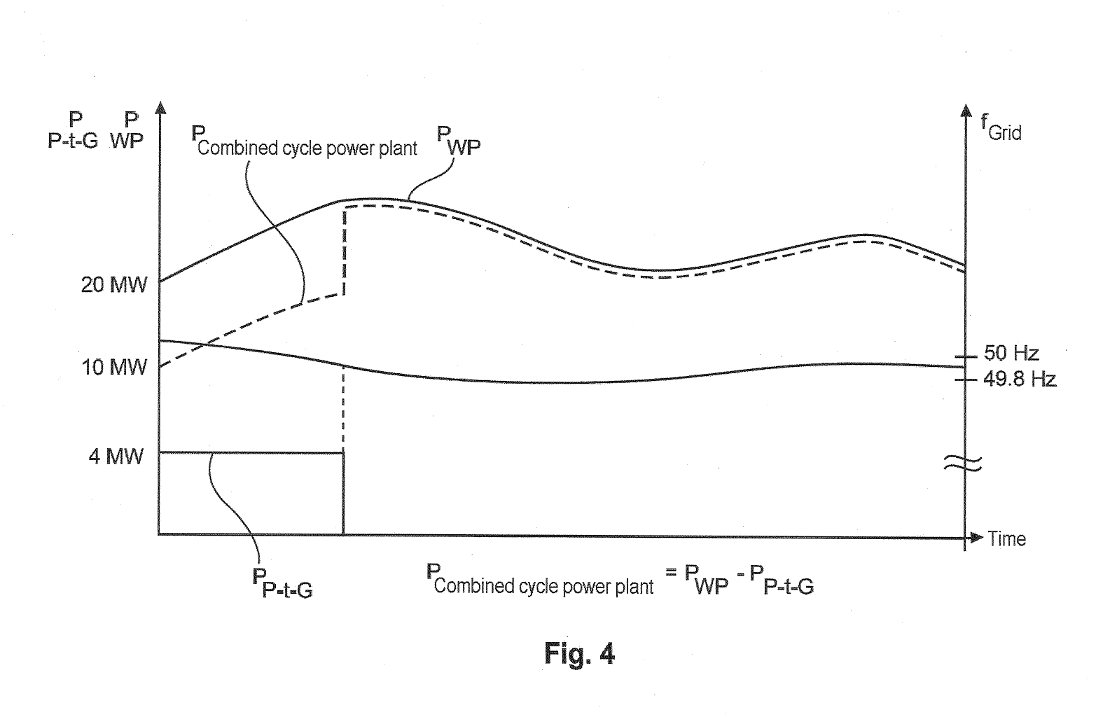

In FIG. 4 it is illustrated that the power-to-gas unit draws a specific electrical power (P_{p-t-G}) provided the grid frequency is above a specific value, for example above 49.8 Hz. If the value of 49.8 Hz is reached or undershot, that is to say if a predetermined underfrequency value is reached, the power consumption of the power-to-gas unit is stopped by switching off or opening the switches of the electrolysis of the power-to-gas unit 23, and the electrical power previously consumed by the power-to-gas unit is thus immediately available to the electrical grid because the previously consumed power is no longer called up from the grid. Consequently, the frequency can recover again relatively quickly, and in any case the grid is supported for the predetermined previously described underfrequency case by stopping the electrical consumption of the power-to-gas unit.

When the power-to-gas unit is part of the combined cycle power plant, wherein the combined cycle power plant comprises a generation unit, for example from a wind farm, the combined cycle power plant provides a power to the electrical grid that is calculated from the difference between the generated power of the generation unit, for example therefore of the power of the wind farm, and the consumed power of the power-to-gas unit. Thus, as soon as the underfrequency value of 49.8 Hz is reached, the power consumption of the power-to-gas unit is reduced to “zero”. Since the wind farm in the illustrated example always generates an electrical power, the electrical power that the combined cycle power plant then, when the consumption of electrical power by the power-to-gas unit is stopped, is equal to the electrical power of the overall wind farm and a much greater proportion of electrical power is thus provided to the electrical grid when the underfrequency value is reached. The power of the combined cycle power plant is illustrated in FIG. 4 by the dashed line (P_{combined cycle power plant}).

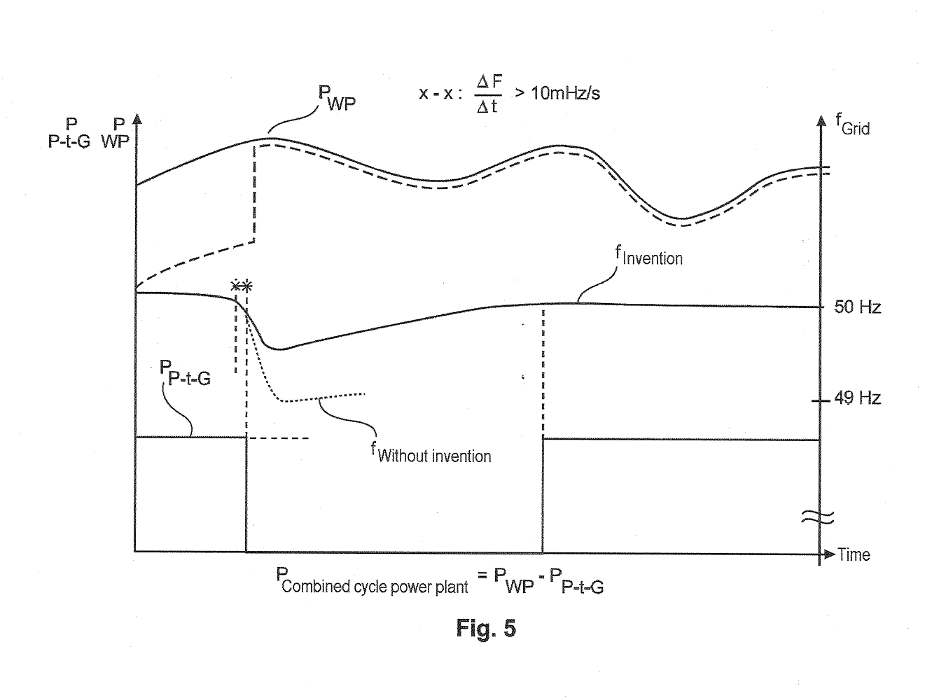

FIG. 5 shows an example in which the triggering event for stopping the power consumption by the power-to-gas unit is not the undershooting of a predetermined grid frequency value, but in which the trigger event consists of the presence of a predetermined frequency drop, that is to say of a frequency gradient. If this exceeds, by way of example, a value of 10 mHz/sec., that is to say if the frequency falls within a second by more than 10 millihertz, this is interpreted as a switching signal and the power consumption by the power-to-gas unit is thus stopped by opening the switches (of the rectifier) of the power-to-gas unit or by reducing the power consumption by a predetermined value. Consequently, there is considerably more electrical power available in the grid within a minimal period of time, that is to say within a few milliseconds, for example 5 to 10 m/sec., because, by stopping the energy consumption by the power-to-gas unit, the total electrical power of the combined cycle power plant can be provided to the grid as electrical power, whereas prior to the triggering switching event the power-to-gas unit still drew a specific power consumption of the electrically generated power from the generation unit.

The dotted line P_{without invention}) (in FIG. 5 indicates how the frequency would behave if the power-to-gas unit were not stopped with the presence of a specific frequency drop, that is to say if the power-to-gas unit were not prevented from continuing to draw energy, but if it were to continue to draw electrical energy as before. As can be seen, the stoppage of the energy consumption by the power-to-gas unit thus leads considerably to the grid support, because it is thus impossible to reach the 49 Hz limit, at which at the latest further consumers would be “dropped” or would be disconnected by the grid controller in order to support the grid.

It goes without saying that both the switching criterion according to FIG. 4 and the switching criterion according to FIG. 5 can be implemented in the same facility (or wind farm) and that it is additionally also possible, provided the power-to-gas unit draws electrical energy, to set this energy such that a stabilization of the feed of the electrical energy of the combined cycle power plant into the electrical grid accompanies this.

With the described power-to-gas arrangement, but also with any other power-to-gas arrangement, it is also possible to construct wind turbines with much lower use of conventional energies, such as oil, diesel, etc. To this end, a smaller wind turbine is first installed on the site, that is to say the place where the wind turbines, the wind farm or the like are to be constructed, and this smaller wind turbine is then connected to a power-to-gas unit, such that during operation thereof, gas is constantly generated. This gas is then made available at the construction site, that is to say the place where the wind turbines, the wind farm or the like will be constructed, to the assemblies located there, that is to say for example cranes, which are operated with this gas, such that hardly any more fossil fuels have to be used as a result in order to construct the wind turbines, the wind farm or the like, but instead these assemblies, such as cranes, trucks or the like, are operated with the gas, that is to say with the fuel, that is generated at the location of construction of the wind turbines by means of a power-to-gas unit.

Of course, it is also possible for the necessary fuel, that is to say the gas, to be generated by means of a power-to-gas unit that is connected to a wind turbine installed in closer proximity.

It is then also advantageous if, at the site of construction of the wind turbines, a gas store is formed that is constantly filled with gas, such that the energy consumers such as cranes, trucks, etc., can also constantly be refueled with gas and therefore the energy balance of a wind turbine project is again significantly improved, in particular also the CO₂ balance, by the power-to-gas unit.

According to one embodiment of the present application, it is described that the power-to-gas unit reduces the consumption of electrical power by a predetermined value or even draws no electrical power when the grid frequency of the electrical grid is below the desired setpoint frequency of the grid by a predetermined frequency value and/or when the grid frequency falls with a frequency gradient, specifically with a change over time (Δf/Δt) of which the magnitude exceeds a predetermined magnitude of change. Consequently, the energy consumption of the power-to-gas unit is thus controlled in a manner depending on the way in which the grid parameter “frequency” in the electrical grid develops.

Alternatively and going beyond the embodiment, it is also possible to control the energy consumption and therefore the operation of the power-to-gas unit in a manner dependent on further grid parameters, such as overfrequency, grid undervoltage, grid overvoltage, reactive power, short circuit, fault ride through, zero ride through in the grid, etc.

In the case of such “grid events”, that is to say when the grid parameters such as frequency, voltage, reactive power, etc., exceed or fall below a specific value, the power of the wind turbine is always reduced. The power of the wind turbines can now be held at its maximum and the reduction of the power fed into the grid can be achieved by making the energy consumption of the power-to-gas unit and therefore in other words the gas production generated by the power-to-gas unit dependent on the overshooting or undershooting of specific grid voltages, short circuits or the overshooting of a grid frequency, etc., in a manner dependent on the aforementioned grid parameters, that is to say the rise or overshoot thereof beyond certain grid parameter values.

When a power-to-gas arrangement is connected and is operated with approximately 90% (±5%) of its nominal power, the consumption power of the power-to-gas device can thus again be increased depending on the previously described grid parameters, such that less electrical power of the wind turbines is fed into the grid, but at the same time the gas production is increased, such that the power of the wind turbines is reduced, which was not the case previously, and therefore some of the electrical energy to be generated potentially is not called up and is not fed into the grid. The controlling intervention in the wind turbine can thus be reduced, and, merely by the operation of the power-to-gas arrangement and the higher electrical power consumption thereof and therefore higher gas production, an electrical power reduction of the power of the wind turbine fed into the grid is achieved. This especially results in the fact that the wind turbine (or a wind farm) can continue to be operated without intervention by a controller, and the entire system generates no energy losses, if specific grid parameters are outside their setpoint range and a reduction of the electrical power fed into the grid is necessary. In the case of a short circuit, the power of the wind turbine normally has to be drastically reduced immediately, possibly even limited to “zero”. Such an intervention means a tremendous controller intervention for the wind turbine, which can only be implemented with difficulty. When a power-to-gas arrangement is connected to the wind turbine, the electrical power of the wind turbine in the case of a grid short circuit can be supplied as completely as possible to the power-to-gas arrangement, such that the wind turbine can first of all continue to be operated.

When, by way of example, a power-to-gas arrangement is operated and this also not only draws its power in normal operation from a wind turbine, but also directly from the grid, the electrical energy consumption from the grid is dropped in the short circuit situation, such that there is thus sufficient potential for the power-to-gas unit to now continue to be operated optimally with its best possible power, and the total power of the power-to-gas unit can then be provided by the wind turbine.

On the basis of this example too, it is clear that a very sophisticated controlling intervention in the wind turbine can thus be spared in the case of a network short circuit or can be significantly milder, and this ultimately increases the reliability of the wind turbine and also makes it possible for electrical power of the wind turbine not to be throttled unnecessarily.

When the grid short circuit or a corresponding event is then cancelled, the wind turbine can then immediately again feed electrical power into the grid and thus support the grid. For the transition, it is also by all means possible that the wind turbine then primarily in the first instance again supports the grid and provides less electrical power to the power-to-gas unit, which ultimately is of no consequence, since the stabilization of the electrical grid is regularly always of paramount importance and as soon as this stability of the electrical grid is re-established, the power-to-gas unit and also the wind turbine can again continue their regular operation.

Consequently, the present disclosure provides a method for operating a power-to-gas arrangement, that is to say an arrangement which generates a gas, for example hydrogen and/or methane or the like, from electrical energy, wherein the power-to-gas unit for generating the gas draws electrical energy from the electrical grid to which the power-to-gas unit is connected, wherein the grid has a predetermined setpoint frequency or a setpoint frequency range, wherein, in the case of a grid short circuit, the power-to-gas unit draws electrical power from a wind turbine or a wind farm, that is to say an accumulation of wind turbines, connected to the power-to-gas unit, and, for the case that the grid short circuit is cancelled, the wind turbines then again feed electrical energy into the grid for grid support and the power-to-gas unit in the meantime draws less electrical energy than is necessary for its nominal power operation, as required, in order to thus also ultimately make a contribution to the grid support.

The above description of the invention applies not only to a grid short circuit, but also for the situations (grid “events”) of fault ride through, zero ride through, etc.

Lastly, a power-to-gas arrangement can be operated such that a wind farm ultimately constantly provides only a specific minimum power and therefore the wind farm as a whole can be considered as a dependable grid variable for the electrical power production. Any further electrical energy produced by the wind farm beyond the minimum power is thus then supplied to the power-to-gas unit.

The above alternatives can be readily implemented when there is no controller to which the grid parameters, that is to say the parameters for frequency, voltage, current, etc., in the grid are supplied (these grid parameters are usually already measured constantly anyway) and which then takes on the control and energy distribution of the wind turbines (or of a wind farm) and of the power-to-gas unit. A further alternative, which is also by all means independent, or also a supplementation to the previously described invention may also lie in the fact that the gas production of the power-to-gas unit is controlled with a STATCOM system. Such a STATCOM is routinely a static synchronous compensator, that is to say a convertor pulse mode, which generates a three-phase voltage system with variable voltage amplitude, of which the voltage is phase-shifted by 90° relative to the corresponding line currents. Inductive or capacitive reactive power can thus be exchanged between the STATCOM and the grid. The STATCOM, in the field of power electronics, forms part of the flexible A/C transmission systems (FATS) and, compared with the functionally similar static reactive power compensation, provides advantages with regard to the stabilization of AC voltage grids, since its reactive power is not dependent on the magnitude of the grid AC voltage.

If the operation of the power-to-gas unit and therefore the gas production of this power-to-gas unit is thus now controlled using a STATCOM system, the power-to-gas arrangement firstly draws its electrical energy from the STATCOM system, which can also be connected simultaneously to the grid. Depending on the current tariffs, specifically on the one hand on the remuneration tariff for electrical power fed into the grid and on the other hand on the current tariff for methane gas, a decision can thus then be made as to how much electrical power of the wind farm (which feeds its power into the grid via the STATCOM system) is introduced into the grid and how much electrical power of the wind farm is introduced into the CH₄ production. Consequently, with such a solution, a method for operating a power-to-gas arrangement is possible, which is connected to a STATCOM system, which is in turn connected to a wind farm and to a grid and has a controller which processes current tariffs, for example the remuneration tariff for electrical power fed into the grid on the one hand and the current tariff for methane gas on the other hand, and controls a grid feed of the electrical energy or the production of gas in the power-to-gas unit depending on which tariff is currently better, specifically either for the electrical power that is fed into the grid or for the methane gas production, such that the ratio of how much electrical power of the wind farm is supplied into the grid and how much electrical power of the wind farm is supplied in the power-to-gas unit and thus in the CH₄ production is possible and is set depending on the most up-to-date tariffs. The STATCOM system is consequently an ideal tool for re-specifying the power distribution (energy distribution) between grid feed and power-to-gas unit operation and therefore for the supply of electrical power of the power-to-gas unit in a manner changing at any time, without having to intervene with the power production of the wind turbine itself. It is furthermore also possible for the STATCOM system to also be connected to an electrical store device, for example an accumulator battery, etc., such that there is then a further possibility to temporarily store electrical energy in order call this on again later from the electrical store and feed it into the grid or to supply it to the power-to-gas unit for the production of CH₄.

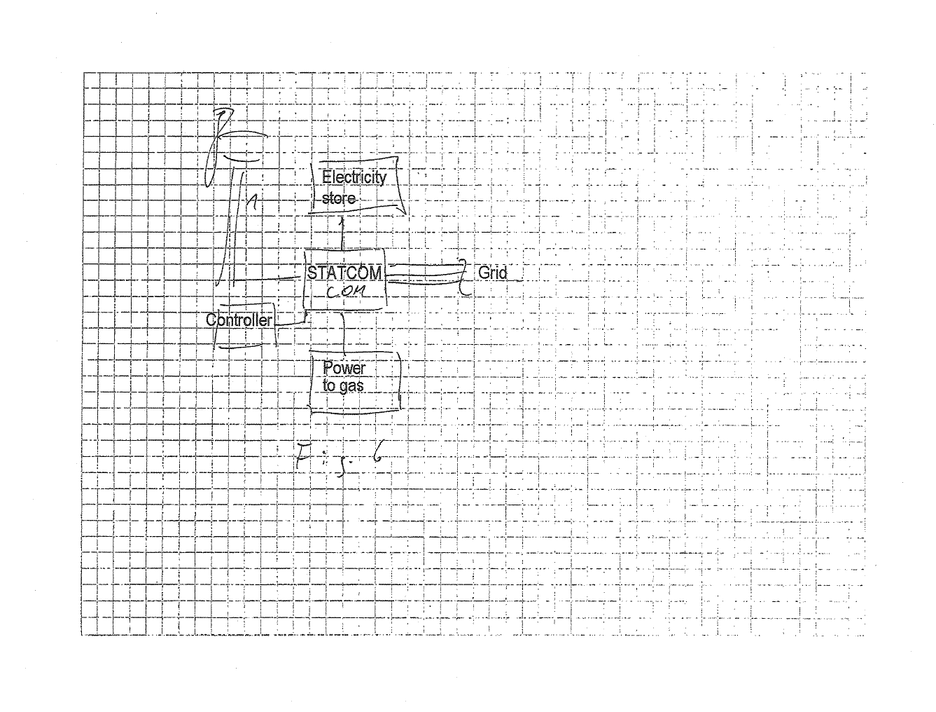

FIG. 6 shows a block diagram of such a STATCOM application with a wind turbine 1, an electrical store, a controller, a power-to-gas unit and a grid. It can be seen that the STATCOM system is connected to the electrical store and/or to the power-to-gas unit and to the wind turbine 1 and to the grid and has a controller which meets the previously described criteria.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for operating a power-to-gas unit, the method comprising:
receiving electrical energy from an electrical grid, to which the power-to-gas unit is connected, wherein the electrical grid has a predetermined setpoint frequency or a setpoint frequency range; and
reducing a consumption of electrical energy received by the electrical grid by a predetermined value or consuming no electrical energy when an operating frequency of the electrical grid is below the predetermined setpoint frequency by a predetermined frequency value or when the operating frequency of the electrical grid drops with a frequency gradient having a change over time (Δf/Δt) with a magnitude that exceeds a predetermined magnitude of change.

2. The method as claimed in claim 1, when the operating frequency of the electrical grid reaches or is below a predetermined first grid frequency value, receiving a minimum electrical energy or no electrical energy from the electrical grid.

3. The method as claimed in claim 1, wherein the predetermined frequency value is 1% of the predetermined setpoint frequency.

4. The method as claimed in claim 1, wherein the power-to-gas unit is coupled to a wind turbine or a wind farm that includes a plurality of wind turbines, and the power-to-gas unit and the wind turbine or the wind farm form a combined cycle power plant such that the electrical energy received by the power-to-gas unit is generated by the wind turbine or the wind farm.

5. A combined cycle power plant comprising:
an electrical grid;
a wind turbine or a wind farm that includes a plurality of wind turbines electrically coupled to the electrical grid, wherein the wind turbine or the wind farm generates electrical energy from wind and provides the electrical energy to the electrical grid; and
a power-to-gas unit electrically coupled to the electrical grid and configured to consume a specific predetermined proportion of the electrical energy generated by the wind turbine and wind farm and convert the electrical energy into a fuel, wherein the electrical grid has a predetermined setpoint frequency, and at least one of:
when a predetermined first grid frequency value that is below the setpoint frequency is reached or is undershot, consumption of electrical power by the power-to-gas unit is at least one of reduced and stopped; and
when the grid frequency falls with a frequency gradient with a change over time (Δf/Δt) having a magnitude that exceeds a predetermined magnitude of change, consumption of electrical power by the power-to-gas unit is at least one of reduced and stopped.

6. The combined cycle power plant as claimed in claim 5, further comprising:
a power line, wherein the power-to-gas unit is electrically coupled to the wind turbine or the wind farm by the power line, and the electrical energy required by the power-to-gas unit for operation thereof is either consumed directly from the wind turbine or from the wind farm or the power-to-gas unit draws the electrical energy for operation of the power-to-gas unit from the electrical grid and into which the wind turbine or the wind farm feeds the generated electrical energy.

7. A method of using a combine cycle power plant that includes a wind turbine, wind farm that includes a plurality of wind turbines, or a photovoltaic plant, the method comprising:
increasing the power fed at an electrical grid that is electrically coupled to the wind turbine, the wind farm or the photovoltaic plant, when at least one of the frequency of the electrical grid falls below a predetermined first grid frequency value and the frequency of the electrical grid falls with a frequency gradient, specifically a change over time (Δf/Δt), of which the magnitude exceeds a predetermined magnitude of change.

8. The method as claimed in claim 1, wherein the predetermined magnitude of change is greater than 0.1 Hz/sec.

9. The method as claimed in claim 8, wherein the predetermined magnitude of change is between 0.2 to 7 Hz/sec.

10. The method as claimed in claim 8, wherein the predetermined magnitude of change is between 0.5 to 2 Hz/sec.

11. The method as claimed in claim 3, wherein the predetermined set point frequency is 50 Hz and the predetermined frequency value is greater than 2%.

12. The method as claimed in claim 3, wherein the predetermined frequency value is greater than 3%.

13. The combined cycle power plant as claimed in claim 5, wherein the fuel is one of hydrogen and methane.
